(19) United States
(12) Patent Application Publication
(10) Pub. No.: US 2009/0067602 A1
(43) Pub. Date: Mar. 12, 2009

(54) APPARATUS, SYSTEMS AND METHODS FOR PRESENTING INFORMATION PERTAINING TO A USER QUERY

(75) Inventor: Daniel L. Rudolph, Castle Rock, CO (US)

Correspondence Address: SEED INTELLECTUAL PROPERTY LAW GROUP PLLC, 701 FIFTH AVENUE, SUITE 5400, SEATTLE, WA, 98104, US

(73) Assignee: EchoStar Technologies Corporation, Englewood, CO (US)

(21) Appl. No.: 11/851,282

(22) Filed: Sep. 6, 2007

(51) Int. Cl. H04M 3/42; G06F 7/00; H04M 3/56

(52) U.S. Cl. 379/202.01; 379/207.13; 707/104.1

(57) ABSTRACT

An embodiment for presenting information pertaining to a user query on a presentation device receives a user query via a user interface, the user query corresponding to a request for information of interest; accesses information associated with a receiving device; identifies at least one party based upon the receiving device information and based upon the information of interest; accesses party information corresponding to the at least one identified party; and presents the party information on a presentation device communicatively coupled to the receiving device.

### TECHNICAL FIELD

The technical field relates to presentation apparatus, systems, and methods for audio/video/data content providers and, more particularly, apparatus, systems, and methods are disclosed for presenting information pertaining to a user query on a presentation device.

### BRIEF SUMMARY

Apparatus, systems and methods for presenting information pertaining to a user query on presentation devices are disclosed. According to one embodiment, a method comprises receiving a user query via a user interface, the user query corresponding to a request for information of interest; accessing information associated with a receiving device; identifying at least one party based upon the receiving device information and based upon the information of interest, the at least one party being identified from a plurality of parties corresponding to the requested information of interest; accessing party information corresponding to the at least one identified party; and presenting the party information on a presentation device communicatively coupled to the receiving device.

According to another embodiment, a system comprises a receiving device communicatively coupled to a presentation device; a user interface communicatively coupled to the receiving device and operable to communicate a user query to the receiving device, the user query corresponding to a request for information of interest; at least one memory with a first database populated with user information associated with the receiving device and populated with information about the receiving device, and with a second database populated with information pertaining to a plurality of parties, each of the parties associated with at least one of a plurality of categories of interest; and a search engine operable to receive the request for the information of interest requested by the user query, operable to search the second database to select at least one party corresponding to the information of interest, and operable to generate party information corresponding to the selected party so that the selected party information is presented on the presentation device.

### BRIEF DESCRIPTION OF THE SEVERAL VIEWS OF THE DRAWINGS

The components in the drawings are not necessarily to scale relative to each other. Like reference numerals designate corresponding parts throughout the several views.

FIG. 1 is an overview block diagram illustrating an exemplary communication network in which embodiments of the user query response system may be implemented.

FIG. 2 is block diagram illustrating in further detail an embodiment in which the user query response system is implemented.

FIG. 3 is a graphical depiction of an exemplary query descriptor presented on a presentation device.

FIG. 4 illustrates a response graphical response descriptor generated in response to the user query.

FIG. 5 is a block diagram illustrating an embodiment of a user query filtering system residing in search engine.

FIG. 6 is a block diagram illustrating an embodiment of a user query filtering system residing in the user query response system.

FIG. 7 is a block diagram illustrating an embodiment of a user query response system with the database residing in the memory of the receiving device.

FIG. 8 illustrates an exemplary response descriptor generated in response to a user query.

FIG. 9 illustrates an exemplary response descriptor generated in response to selection of an item by a user.

FIG. 10 illustrates an exemplary response descriptor generated in response to selection of an item by the user

FIG. 11 is a flowchart illustrating a process used by an exemplary embodiment of the user query response system.

### DETAILED DESCRIPTION

A. Communication System Overview

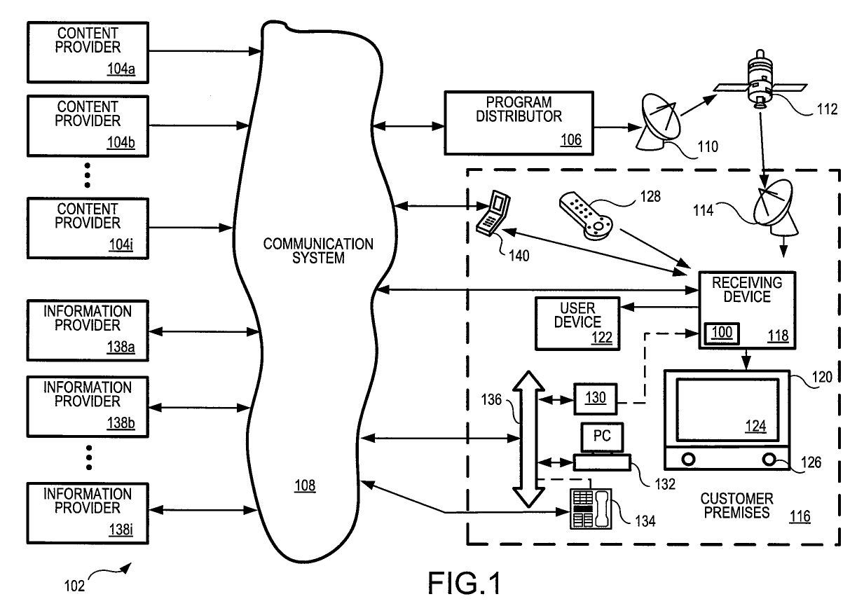

FIG. 1 is an overview block diagram illustrating an exemplary communication system 102 in which embodiments of the query response system 100 may be implemented. It is to be appreciated that FIG. 1 is just one example of a communications system and that the various embodiments discussed herein are not limited to such exemplary systems. Communication system 102 can include a variety of communication systems and can use a variety of communication media including, but not limited to, satellite wireless media.

Television service providers provide their customers a multitude of audio/video and/or data programming (hereafter, collectively and/or exclusively “programming”). Such programming is often provided by use of a receiving device 118 (FIG. 1) communicatively coupled to a presentation device 120 configured to receive the programming.

Receiving device 118 may interconnect to one or more communications media or sources (such as a cable head-end, satellite antenna, telephone company switch, Ethernet portal, off-air antenna, peer-to-peer, or the like) that provide the programming. The receiving device 118 commonly receives a plurality of programming by way of the communications media or sources described in greater detail below. Based upon selection by the user, the receiving device 118 processes and communicates the selected programming to the one or more presentation devices 120.

For convenience, the receiving device 118 may be interchangeably referred to as a “television converter,” “receiver,” “set-top box,” “television receiving device,” “television receiver,” “television recording device,” “satellite set-top box,” “satellite receiver,” “cable set-top box,” “cable receiver,” and/or “television tuner.” Accordingly, the receiving device 118 may be any suitable converter device or electronic equipment that is operable to receive programming. Further, the receiving device 118 may itself include user interface devices, such as buttons or switches. In many applications, a remote 128 is operable to control the presentation device 120 and/or other user devices 122.

Examples of a presentation device 120 include, but are not limited to, a television (TV), a personal computer (PC), a sound system receiver, a digital video recorder (DVR), a compact disk (CD) device, a game system, or the like. Presentation devices 120 employ a display 124, one or more speakers 126, or other output devices to communicate video and/or audio content to a user. In many implementations, one or more presentation devices 120 reside in or near a customer's premises 116 and are communicatively coupled, directly or indirectly, to the receiving device 118.

A plurality of content providers 104a-104i provide program content, such as television content or audio content, to a distributor, such as the program distributor 106. Exemplary content providers 104a-104i include television stations which provide local or national television programming, special content providers which provide premium based programming or pay-per-view programming, or radio stations which provide audio programming.

Program content, interchangeably referred to as a program, is communicated to the program distributor 106 from the content providers 104a-104i through suitable communication media, generally illustrated as communication system 108 for convenience. Communication system 108 may include many different types of communication media, now known or later developed. Non-limiting media examples include telephony systems, the Internet, internets, cable systems, fiber optic systems, microwave systems, asynchronous transfer mode (ATM) systems, frame relay systems, digital subscriber line (DSL) systems, radio frequency (RF) systems, and satellite systems. Further, program content communicated from the content providers 104a-104i to the program distributor 106 may be communicated over combinations of media. For example, a television broadcast station may initially communicate program content, via an RF signal or other suitable medium, that is received and then converted into a digital signal suitable for transmission to the program distributor 106 over a fiber optics system. As another nonlimiting example, an audio content provider may communicate audio content via its own satellite system to the program distributor 106.

In at least one embodiment, the received program content is converted by one or more devices (not shown) as necessary at the program distributor 106 into a suitable signal that is communicated (i.e.; “uplinked”) by one or more antennas 110 to one or more satellites 112 (separately illustrated herein from, although considered part of, the communication system 108). It is to be appreciated that the communicated uplink signal may contain a plurality of multiplexed programs. The uplink signal is received by the satellite 112 and then communicated (i.e., “downlinked”) from the satellite 112 in one or more directions, for example, onto a predefined portion of the planet. It is appreciated that the format of the above-described signals are adapted as necessary during the various stages of communication.

A receiver antenna 114 that is within reception range of the downlink signal communicated from satellite 112 receives the above-described downlink signal. A wide variety of receiver antennae 114 are available. Some types of receiver antennae 114 are operable to receive signals from a single satellite 112. Other types of receiver antennae 114 are operable to receive signals from multiple satellites 112.

The receiver antenna 114 can be located at a customer premises 116. Examples of customer premises 116 include a residence, a business, or any other suitable location operable to receive signals from satellite 112. The received signal is communicated, typically over a hard-wire connection, to a receiving device 118. Receiving device is a conversion device that converts, also refereed to as formatting, the received signal from antenna 114 into a signal suitable for communication to a presentation device 120 and/or a user device 122. Often, the receiver antenna 114 is of a parabolic shape that may be mounted on the side or roof of a structure. Other antenna configurations can include, but are not limited to, phased arrays, wands, or other dishes.

The received signal communicated from the receiver antenna 114 to the receiving device 118 is a relatively weak signal that is amplified, and processed and/or formatted, by the receiving device 118. The amplified and processed signal is then communicated from the receiving device 118 to a presentation device 120 in a suitable format and/or to a user device 122. It is to be appreciated that presentation device 120 may be any suitable device operable to present a program having video information and/or audio information.

User device 122 may be any suitable device that is operable to receive a signal from the receiving device 118, another endpoint device, or from other devices external to the customer premises 116. Additional non-limiting examples of user device 122 include optical media recorders, such as a compact disk (CD) recorder, a digital versatile disc or digital video disc (DVD) recorder, a digital video recorder (DVR), or a personal video recorder (PVR). User device 122 may also include game devices, magnetic tape type recorders, RF transceivers, and personal computers (PCs).

Interface between the receiving device 118 and a user (not shown) may be provided by a hand-held remote device 128. Remote 128 typically communicates with the receiving device 118 using a suitable wireless medium, such as infrared (IR), RF, or the like. Other devices (not shown) may also be communicatively coupled to the receiving device 118 so as to provide user interface. Non-limiting examples include game device controllers.

The receiving device 118 may receive programming partially from, or entirely from, another source other than the above-described receiver antenna 114. Other embodiments of the receiving device 118 may receive locally broadcast RF signals, or may be coupled to communication system 108 via any suitable medium. Non-limiting examples of medium communicatively coupling the receiving device 118 to communication system 108 include cable, fiber optic, or Internet media.

Customer premises 116 may include other devices which are communicatively coupled to communication system 108 via a suitable media. For example, but not limited to, some customer premises 116 include an optional network 136, or a networked system, to which receiving devices 118, presentation devices 120, and/or a variety of user devices 122 can be coupled, collectively referred to as endpoint devices. Non-limiting examples of network 136 include, but are not limited to, an Ethernet, twisted pair Ethernet, an intranet, a local area network (LAN) system, or the like, One or more endpoint devices, such as PCs, data storage devices, TVs, game systems, sound system receivers, Internet connection devices, digital subscriber loop (DSL) devices, wireless LAN, WiFi, Worldwide Interoperability for Microwave Access (WiMax), or the like, are communicatively coupled to network 136 so that the plurality of endpoint devices are communicatively coupled together. Thus, the network 136 allows the interconnected endpoint devices, and the receiving device 118, to communicate with each other. Alternatively, or in addition, some devices in the customer premises 116 may be directly connected to the communication system 108, such as the telephone 134 which may employ a hardwire connection or an RF signal for coupling to communication system 108.

A plurality of information providers 138a-138i are coupled to communication system 108. Information providers 138a-138i may provide various forms of content and/or services to the various devices residing in the customer premises 116. For example, information provider 138a may provide requested information of interest to PC 132. Information providers 138a-138i may further perform various transactions, such as when a user purchases a product or service via their PC 132.

The above description of the communication system 102 and the customer premises 116, and the various devices therein, is intended as a broad, non-limiting overview of an exemplary environment in which various embodiments of the query response system 100 may be implemented. The communication system 102, and the various devices therein, may contain other devices, systems and/or media not specifically described herein.

B. User Query Response System Overview

An individual may desire to contact a person, organization, or business using their telephone, cell phone, or other communication device. Also, the individual may be interested in the physical location of the person, organization, or business of interest. To make a telephone call to the person, organization, or business of interest, the individual must first obtain the telephone number, or other suitable identifier, of the person, organization, or business of interest. In other situations, the individual may generally know a category of interest, and may wish to locate and contact a provider of that good or service pertaining to the category of interest.

Typically, the individual may go to a source of information to retrieve the telephone number, address, and/or other suitable identifier of a person, organization, or business, or go to a category-based information source that identifies one or more providers of the good or service pertaining to the category of interest. For example, sources of information containing the telephone number of the person, organization, or business include telephone books, various Internet service provider sites, or dial-up information services. Such sources may be sorted by the name of the person, organization, or business of interest, or sorted by categories of interest.

In some situations, it is very inconvenient for the individual to access the above-described information for the person, organization, or business of interest, such as, but not limited to, a telephone number. For example, the individual may not have physical mobility (e.g., bedridden with an illness or the like) or may be occupied with another task (e.g., an individual performing a task, such as a parent attending one or more children while watching educational TV, or a fan watching a sports game, such as World Cup soccer, the Super Bowl, or other event) such that it is not convenient or possible to retrieve a phone book or log into the Internet to obtain sufficient information to contact the person, organization, or business of interest. Further, the individual may not precisely know the name and/or address of the person, organization, or business so as to be able to obtain sufficiently accurate information to identify the person, organization, or business of interest.

In other situations, the individual may not be in a location which the individual is familiar with. As a non-limiting example, an individual may be out of town on business or pleasure, and thus not have access to a phone book or the Internet. Or, the individual may be traveling in a recreational vehicle (RV), boat, or the like. The individual may further not know the names of the person, organization, or business of interest in the unfamiliar location. And, the individual in this situation may not have a sufficient knowledge of the geography of the location so as to meaningfully select a person, organization, or business of interest.

To illustrate, consider the traveler staying in a hotel or their RV. The individual may wish to order a pizza for delivery. It may be a relatively difficult task to locate and access a source of local information that can assist the individual to identify possible pizzerias, and even more difficult for the individual to select a nearby pizzeria that is able to deliver the pizza. Further, it may be difficult for the individual to select a pizzeria without knowing the available pizza selection options and/or costs. To determine pizza selection options and/or costs, the individual would otherwise have to call multiple pizzerias to obtain sufficient information to select a pizzeria that best suits the individual's particular needs.

In many of the above-described situations, individuals wishing to identify and/or contact a person, organization, or business using their telephone, cell phone, or other communication device have convenient access to a presentation device 120, such as a television, having an embodiment of the query response system 100 therein. Accordingly, the above-described traveler in a hotel or an RV may obtain sufficient information to order their pizza using the query response system 100, described in greater detail hereinbelow.

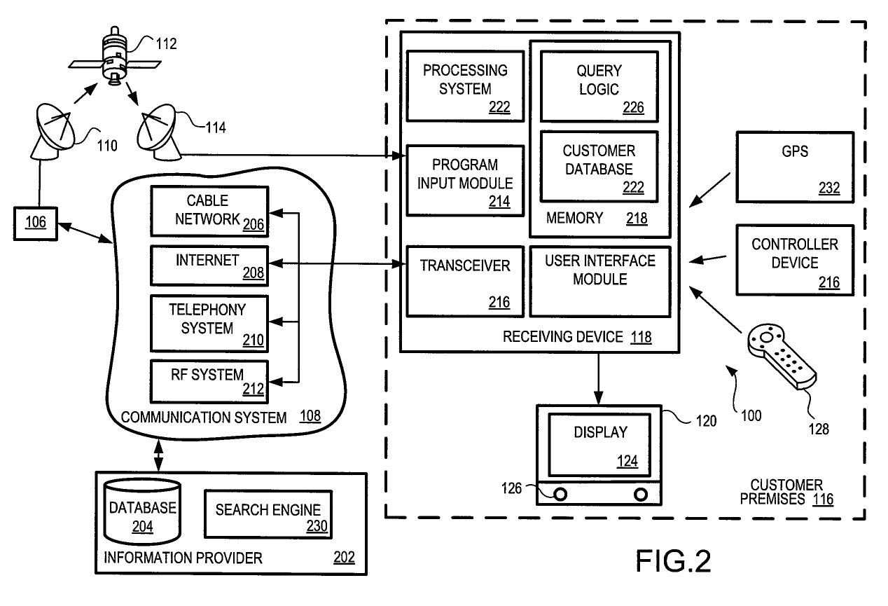

FIG. 2 is block diagram illustrating in further detail an embodiment in which the query response system 100 is implemented. The user wishing to find information pertaining to a person, organization, or business, or wishing to obtain information for a provider of a good or service pertaining to a category of interest, initiates the process of obtaining the information of interest by communicating a user query to the receiving device 118 having an embodiment of the query response system 100 therein.

In the non-limiting exemplary environment illustrated in FIG. 2, an information provider 202 is bi-directionally communicatively coupled to the communication system 108. Database 204 contains information pertaining to the user query that will be accessed and/or retrieved in response to an information request generated by the query response system 100, described in greater detail hereinbelow. The presented information pertaining to the user query may be interchangeably referred to as party information herein.

The receiving device 118 is communicatively coupled to the database 204 via at least one intermediary media of the communication system 108. These intermediary media may include, but are not limited to, the above-described satellite system 102, a cable network 206, the Internet 208, a telephony system 210 or a radio frequency (RF) system 212.

A receiving device 118 embodiment with a query response system 100 includes a program input module 214, a transceiver 216 (or a transmitter, depending upon the embodiment), memory 218, user interface module 220, and a processing system 222. Customer database 224 and/or query logic 226 may reside in memory 218. Query logic 226 may be a stand-alone logic module or may be integrated with other logic. Customer database 224 may be a stand-alone database or may be integrated with other information. In embodiments with database 204 in the receiving device 118, described in greater detail below, the databases 204 and 224 may be integrated.

Program input module 214, is coupled to a suitable media, such as, but not limited to, the satellite system or a cable media. Program input module 214 is operable to receive the programming from the program distributor 106. Examples of program input module 214 include but are not limited to, a tuner or other suitable device coupleable to communication system 108 to receive programming. Program input module 214 may also have other functionality.

The query response system 100 is responsive to a user query communicated to the receiving device 118. In some embodiments, the user query may be communicated from remote 128. The user may construct a user query by actuating input devices, such as buttons, key pads, a touch sensitive menu, or the like, residing on the surface of the remote 128, and/or another controller device 228.

User interface module 220 is operable to receive communications from the remote 128 and/or controller device 228. Any suitable wireless communication media may be used, including, but not limited to, infrared, radio frequency, laser, ultrasound, or ultra frequency. A wire-based media may also be used.

The user query may be constructed in various manners and/or formats depending upon the nature of the receiving device 118, remote 128, and/or controller device 228. For example, if the remote 128 contains a plurality of alpha-numeric keys, the user may construct the user query by directly entering a string of suitable alpha-numeric symbols. A “triple-tap” key system may be used by other embodiments, wherein keys on remote 128 each correspond to a plurality of alpha-numeric symbols whereby the user sequentially scrolls through the assigned alpha-numeric symbol sequence to select a desired symbol. Other embodiments may provide for an interactive menu system viewable on presentation device 120, or viewable on a display of remote 128, whereby the user constructs the user query via the presented menu system.

Embodiments may be communicatively coupled to controller devices 228 that are also operable to construct and communicate a user's query to the receiving device 118. Non-limiting examples of the controller device 228 include a keyboard pad, a game controller, a mouse device, or a PC, cellular phone, personal device assistant (PDA) or the like. These controller devices 228 may have keys, buttons, or the like, used by the user to construct a user query. Or, controller devices 228 may employ a menu-based selection system so that the user may construct the user query by selecting available menu choices presented on presentation device 120 or controller device 228.

It is to be appreciated that it is not convenient to list or describe herein all of the possible forms of remotes 128 and controller devices 228, or their methodology and media of communication with the receiving device 118. Remote 128 and controller device 228 are operable to construct and communicate a user's query to the receiving device 118. Some remotes 128 and/or controller devices 228 are appreciated to have other functionality not necessarily related to the query response system 100. Other types of remotes 128 and controller devices 228 may be dedicated devices operable to construct and/or communicate a user query to the receiving device 118, or may be operable to allow a user to select available menu choices via the receiving device 118.

Once a user query has been received, the query response system 100 processes the user query into an information request. Processing system 224 may retrieve and execute the query logic 226 to generate an information request or the like. In one embodiment, the information request is communicated to a search engine 230. In some implementations, search engine 230 resides at the information provider 202, as illustrated. Alternatively, or in addition to, search engine 230 may reside in alternative locations, such as in the receiving device 118, at the program distributor 106, or in any convenient location.

Search engine 230 is operable to locate and retrieve information pertaining to the user query from database 204 that contains information of interest pertaining to the user query. Any suitable search engine 230 may be used by the various embodiments. One non-limiting search engine 230 uses a keyword search based on the user query (filtered or unfiltered).

A user query may be processed into a filtered user query, described in greater detail hereinbelow. Then, embodiments of the query response system 100 communicate the filtered user query to the search engine 230 such that database 204 is accessed to retrieve information pertaining to the filtered user query. The search engine 230 retrieves information pertaining to the user query, which is then communicated back to the query response system 100.

In some embodiments, an information request generated from a user query may be processed into a filtered information request by the search engine 230, described in greater detail hereinbelow. Then, the search engine 230 searches database 204 to access and retrieve information pertaining to the filtered information request, which is then communicated back to the query response system 100.

The returned information received from the search engine 230 may be further filtered by embodiments of the query response system 100 such that the user receives information that is anticipated to be more relevant to the user's particular needs. For example, the information retrieved from the database 204 may be filtered based on geographic location based upon information known about the location of the presentation device 120 and/or receiving device 118. Alternatively, or in addition to, location information or the like may be provided by the user. Such filtering is described in greater detail hereinbelow.

Some embodiments may be operable to receive information from global positioning system (GPS) 232. As described in greater detail below, directions may be determined from information provided by the GPS 232. GPS 232 may be internal to, integrated with, or coupled to the receiving device 118.

Once the returned information has been received, the query response system 100 causes the presentation device 120 to present a response having the information pertaining to the user query. The response will contain sufficient information such that the user will be able to conveniently identify at least one person, organization, or business, and view sufficient contact information (name, phone number, address, provided services/products, etc.) to contact the person, organization, or business. The process generating a response based upon the received user query will be described in greater detail hereinbelow.

As noted above, some embodiments may optionally include the search engine 230 and database 204. If search engine 230 and database 204 are implemented in embodiments of a receiving device 118, the response to a query may be generated within the receiving device 118. In such embodiments, the database 204 may be loaded and/or updated at convenient times, such as when the receiving device 118 is not being used or when bandwidth is available to the receiving device 118 over the media which programming is received from the program distributor 106. Alternatively, or in addition to, the database 204 may be loaded and/or updated at convenient times via a suitable backchannel media, such as through the transceiver 216.

C. User Queries

User queries may be constructed in a wide variety of formats. A first exemplary type of user query pertains to requesting information about a person, organization, or business. A second exemplary type of user query pertains to requesting information about a category of interest, such as a product category or service category, for which one or more persons, organizations, or businesses which provide the product or service are identified.

As noted above, in a first exemplary type of user query, the user may be interested in a person, organization, and/or business. Typically, the user is interested in obtaining at least a phone number and/or address of the person, organization, and/or business. The user may also desire relevant supplemental information about the person, organization, or business. For example, the user may be interested in a supplemental listing of additional phone numbers, family members of the person of interest, their respective phone number, or a brief biography of the person of interest. As another example, assuming that the user is interested in an organization or business, the user may be interested in supplemental information describing the products and/or services provided by the organization or business.

In a different exemplary type of user query, the user may be interested in a product and/or service. Typically, the user is interested in obtaining at least a phone number and/or address of the organization or business that provides the product and/or service of interest. Often, the user is interested in information for a plurality of organizations or businesses that provides the product and/or service of interest so that the user may selectively choose where to go for the product and/or services.

The product and/or service of interest is typically categorizable using a single keyword, or a relatively small number of keywords. For example, if the user is hungry and wants a pizza, a single keyword “pizza” could categorize the user's interest. Alternatively, the keyword phrase “Italian restaurant” could categorize the user's interest.

The user may also desire relevant supplemental information about the person, organization, business, and the product and/or service of interest. For example, the user may be interested in a supplemental listing of several providers, or a listing of alternative type products or services provided by the organization or business. In some embodiments, supplemental information may include a listing of products or services provided, such as a pizza menu from an identified pizzeria.

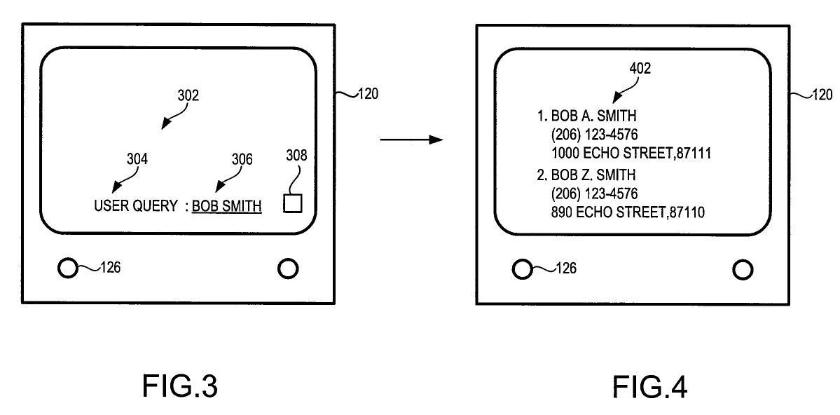

FIG. 3 illustrates a graphical query descriptor 302 of an exemplary user query generated by the query response system 100 and presented on presentation device 120. FIG. 4 illustrates an exemplary, geographic-based response descriptor 402 generated in response to the user query, described in greater detail hereinbelow. The descriptor 402 may be any suitable graphical indicia that is communicative of location information to a user. The descriptor 402 may be comprised of alpha-numeric symbols, may be graphical symbols, or a combination thereof.

The query descriptor 302 describes at least one attribute of the user query. The illustrated query descriptor 302 of this example indicates that the user is interested in obtaining information pertaining to an individual named “Bob Smith.” The user has, at this juncture, constructed a user query and communicated the user query to the query response system 100 using the above-described remote 128 or other suitable controller device 228.

The query descriptor 302 generated by the query response system 100 includes a first portion 304 indicating at least the receipt of the user query. The first portion 304 is a standardized descriptor presented on the presentation device 120 and indicates to the user that a user query has been received by the query response system 100. Further, the first portion 304 may include other suitable information of interest. The first portion 304 may be presented as a string of alpha-numeric symbols, one or more graphical symbols or the like, and/or with any suitable visual aids such as color, flashing, or other font or symbol controlled attributes. In some embodiments, the first portion 304 is optional.

When the user is requesting information pertaining to a category of interest, a suitable query descriptor 302 is generated by the query response system 100. The query descriptor 302 may have a first portion identical to the above-described first portion 304 generated in response to a user query for information pertaining to a person, organization, or business. Or, the first portion of the query descriptor 302 for a user query pertaining to a category may be different than described above. For example, a predefined phrase of alpha-numeric characters associated with the category (e.g.: “pizza”) or/or an icon or symbol (e.g.: symbol that looks like a pizza or a photograph of a pizza) may be presented.

The query descriptor 302 generated by the query response system 100 includes a second portion 306 indicating at least the receipt of the user query. The second portion 306 is also a generated descriptor presented on the presentation device 120. The second portion 306 is generated based on the content of the user query and indicates to the user that the user's query has been received and understood by the query response system 100. The second portion 306 may be a verbatim listing of the user query, may be an interpretation of information in the user query, or may be a predefined indicator. The second portion 306 may also be presented as a string of alpha-numeric symbols, one or more graphical icons or the like, and/or with any suitable visual aids such as color, flashing, or other font controlled attributes. In some embodiments, the second portion 306 is optional.

In some embodiments, a confirmation feature is used by the query response system 100. For example, the user, once satisfied that the nature of their query as indicated by the second portion 306 is correct, selects a region such as select box or the like to confirm the user query. The user may indicate confirmation via a menu driven system or by actuation of a button or key on the remote 128 or controller device 228 depending upon the embodiment. Once the confirmation is entered, embodiments of the query response system 100 generate the information request (or a filtered information request).

Once the user query has been received, or confirmed by embodiments having the above-described confirmation feature, the query response system 100 causes the search engine 230 to access the database 204 such that information pertaining to the user query is retrieved, returned and then presented to the user.

D. User Query Filtering

Filtering of a user query may be performed by some embodiments of the query response system 100 and/or by the search engine 230. Receiving device 118 is associated with one or more customers. Information about the customer associated with the receiving device 118 is stored in the customer database 224. Included in the customer information may be the identity or name of the customer (and thus, presumably the user or a related party generating the user query), a location of the receiving device 118 (customer address, city, zip code, state, country), a phone number, a phone number area code, an e-mail address, or other suitable information. For convenience, this information pertaining to the customer, and/or to the receiving device 118, is referred to as “user information” herein. Further, a user operating the query response system 100 may not be the same individual as the above-described customer. However, the retrieved information that is subsequently associated with the user is also referred to as “user information” herein.

The database 224 may reside in memory 218, or in other suitable locations, such as, but not limited to, program distributor 106, information provider 202, or a customer service center (not shown). The database 224 may also include information pertaining to the customer bill payment history, credit scores, types of programs watched, sports programs preferred, ordered on pay-per-view, and/or other specific information about the user. Some customer-specific information is confidential, and some of it is highly confidential. The owner of the database 224 does not need to release this confidential customer information for it to be useful to respond to queries by the user. The owner of the database 224 may use the address of the customer or receiving device 118 to locate pizza stores nearby. They may also use prior ordering patterns of the user, such as buying pizza from the same store location during sporting events to more easily respond to the user's query. For example, the presentation may initially present the locations from which pizza was recently or most frequently ordered.

Filtering is a criteria-based method of processing information associated with the user query. Filtering reduces the scope of the searching performed in database 204, reduces the scope of the returned information pertaining to the user query, and/or reduces the scope of the information presented on presentation device 120. Any suitable filtering criteria may be used for filtering. Information from database 224 can include, but is not limited to, an address, city, zip code, state, country, phone number, phone number area code, e-mail address, or other suitable information. Further, filtering information may be contained within the user query. For example, the user may specify information such as, but not limited to, a price point or service criteria which further defines the information of interest (e.g., “pizzas less than $12.00”, or “pizzas for delivery”).

In embodiments where the customer premises 116 is mobile, such as in a boat or recreational vehicle, the user may input filtering information pertaining to their current location. For example, the address, city, zip code, state, country, phone number, phone number area code, e-mail address of the current location may be used as filtering criteria.

Multiple filtering criteria may be combined and/or automatically generated. For example, location information may be determined from related information ascertainable during the process of communicating an information request over the communication system. As another example, location information may be ascertained if the information request is communicated over RF system 212 by associating the location of the receiving RF cell site with the location of the customer.

Filtering criteria may be predefined. For example, if the location is known, a predefined geographical criteria about the location may be used for filtering. A radius may be defined to be “x” miles such that the returned information identifies a person, organization, or business within the predefined radius from the location. As another example, an area of “x” square miles may be defined such that the returned information identifies a person, organization, or business within the predefined area. In another embodiment, the user query may be filtered to so that the query is directed to information within a predefined geographic region, such as a region defined by the customer's zip code, or a region defined by the customer's phone area code, or another predefined geographic region. The geographic region may also be expanded to include one or more adjacent corresponding geographic regions, such geographic regions identified by the filtering zip code or area code.

Another example of a predefined filtering criteria is a limit to the number of items returned and/or presented. For example, a presentation of ten items may be predefined. Thus, ten pizzerias may be returned or presented if the user query pertains to “pizzas” or “pizza delivery” or “location of last ordered pizza” or “most frequently ordered pizza.” Further, combined filtering criteria may be ordered in a hierarchy. Thus, if the filtering criteria is within an “x” mile radius from the location and a limit of ten items is presented, the ten closest items may be presented (e.g., the ten closest pizzerias to the customer premises 116). Or, if price is a filtering criteria, ten cheapest pizzerias, ordered and limited by location, may be returned or presented to the user.

Information pertinent for filtering information pertaining to the user query is retrieved from database 224. The information from database 224 is retrieved or communicated to the search engine 230 or to the query response system 100.

Filtering may occur at any suitable stage in the process of receiving a user query, generating an information request, performing a search of database 204, communicating information pertaining to the user request, or generating the response descriptor 402. For example, embodiments of the query response system 100 may retrieve the customer address or other location information and incorporate it with the user query when the information request is generated. Alternatively, the search engine 230 may perform filtering prior to accessing the database 204. Or, the search engine 230 may access the database 204, and then perform filtering on the retrieved information pertaining to the user query. Or, the query response system 100 may perform filtering on the returned information.

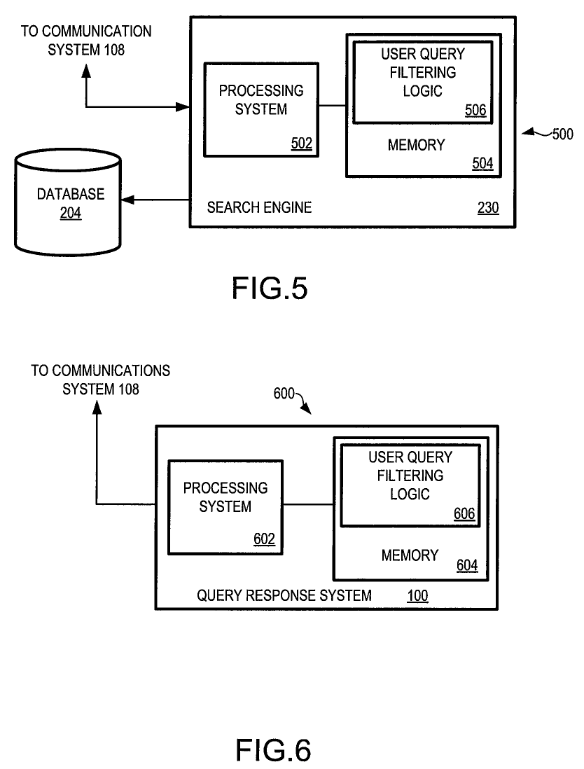

FIG. 5 is a block diagram illustrating an embodiment of a user query filtering system 500 residing in search engine 230. Search engine 230 includes a processing system 502 and a memory 504. User query filtering logic 506 resides in memory 504, and is retrieved and executed by the processing system 502 to perform the above-described filtering. It is appreciated that the search engine 230 may be part of a larger, multi-function system (not shown), or may be a dedicated stand-alone system as conceptually illustrated. The above-described components may reside together as illustrated, or may be distributed in other convenient locations.

FIG. 6 is a block diagram illustrating an embodiment of a user query filtering system 600 residing in the query response system 100. User query response system 100 includes a processing system 602 and a memory 604. User query filtering logic 606 resides in memory 604, and is retrieved and executed by the processing system 602 to perform the above-described filtering.

It is appreciated that the query response system 100 may be part of a larger, multi-function system (not shown), or may be a dedicated stand-alone system as conceptually illustrated. Further, the query response system 100 may reside in the receiving device 118, or may reside separately in another suitable location. The above-described components may reside together as illustrated, or may be distributed in other convenient locations.

E. Retrieval of Information Pertaining to the Query

As noted above, retrievable and/or searchable information pertaining to the user query resides in a suitable database 204. In FIG. 2, database 204 resides with information provider 202. Embodiments of the search engine 230 are operable to access and retrieve information from database 204 pertaining to the user query. The user query may be filtered. The accessed information pertaining to the user query, filtered or unfiltered, is communicated over the communication system 108, via one of the above-described intermediary media (cable network 206, Internet 208, telephony system 210, or RF system 212) or another suitable media, to the query response system 100.

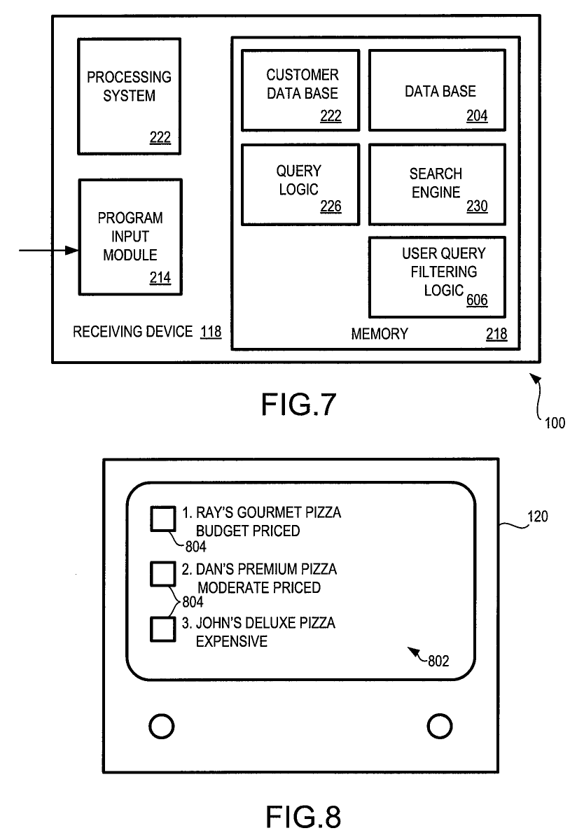

FIG. 7 is a block diagram illustrating an embodiment of a user query response system 100 in receiving device 118. Database 204 resides in the memory 218 of the receiving device 118. Here, the search engine 230 also resides in the receiving device 118, and is illustrated as logic residing in the memory 218. Further, the above-described user query filtering logic 606 is illustrated as residing in memory 218. The search engine 230 is retrieved and executed by a processing system 222 to perform the above-described searching and accessing of information residing in the database 204. The user query filtering logic 606 is retrieved and executed by the processing system 222 to perform the above-described filtering. In some embodiments, the search engine 230 and/or user query filtering logic 606 may reside as a separate components in another convenient location in the receiving device 118.

In the embodiment illustrated in FIG. 7, the database 204 is periodically updated with current information at a convenient time. The information may be updated by the program distributor 106 (FIG. 1), the information provider 202, or another entity, and communicated over communication system 108, or even via satellite 112. The information may be communicated to the database 204 in any suitable manner or format. Also, the information stored in database 204 may be downloaded or updated in response to receiving a user query so that the most currently available information is accessed and searched.

Information residing in the database 204 may be limited in a predefined manner to include information that is anticipated to be of the nature that a user may be interested in. For example, information pertaining to a plurality of predefined categories may be stored in database 204. Further, the information stored in database 204 may be limited by some relevant criteria, such as, but not limited to, the above-described filtering criteria relating to geographic areas.

Processing systems 222, 502, and/or 602 are typically a commercially available processor. Examples of commercially available processing systems 502, 602, and/or 702 include, but are not limited to, an 80×86 or Pentium series microprocessor from Intel Corporation, U.S.A., a PowerPC microprocessor from IBM., a Sparc microprocessor from Sun Microsystems, Inc., a PA-RISC series microprocessor from Hewlett-Packard Company, or a 68xxx series microprocessor from Motorola Corporation. Any such embodiments of the processing systems 222, 502, and/or 602 now known or later developed, are intended to be within the scope of this disclosure.

When query filtering logic 506, 606 is implemented as software and stored in memory 218, 504, and/or 604, one skilled in the art will appreciate that query filtering logic 506, 606 can be stored on any computer-readable medium for use by or in connection with any computer and/or processor related system or method. In the context of this document, memories 218, 504, and/or 604 are computer-readable medium that is an electronic, magnetic, optical, or other another physical device or means that contains or stores a computer and/or processor program. Query filtering logic 506, 606 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with query filtering logic 506, 606. In the context of this specification, a “computer-readable medium” can be any means that can store, communicate, propagate, or transport the program associated with query filtering logic 506, 606 for use by or in connection with the instruction execution system, apparatus, and/or device. The computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium, could even be paper or another suitable medium upon which the program associated with logic 908 is printed, as the program can be electronically captured, via for instance optical scanning of the paper or other medium, then compiled, interpreted, or otherwise processed in a suitable manner, if necessary, and then stored in memory 218, 504, and/or 604.

F. Response to Query

As noted above, FIG. 4 illustrates a response descriptor 402 generated in response to the above-described exemplary user query pertaining to “Bob Smith” by the query response system 100. The response descriptor 402 is presented on presentation device 120, or is presented on another suitable display. The illustrated exemplary response descriptor 402 indicates that accessed information corresponds to an individual of interest associated with a user query for “Bob Smith.”

In this simplified illustrative example, two listings of information for individuals “Bob Smith” are provided in the response descriptor 402. Thus, it is to be appreciated that the returned information pertaining to the user query resulting from the search of database 204 found the two individuals “Bob Smith” (with or without filtering). Accordingly, the user who presumably generated the user query would be able to select one of the individuals “Bob Smith” and contact them in a desired manner.

FIG. 8 illustrates another exemplary response descriptor 802 generated in response to the above-described exemplary user query pertaining to “pizza” by the query response system 100. The response descriptor 802 is presented on presentation device 120, or is presented on another suitable display. The illustrated exemplary response descriptor 802 indicates that accessed information corresponds to a plurality of businesses that provide pizzas.

Further, supplemental information may be presented with each listed item, such as an address, phone number, directions, and/or other pertinent generalized information of interest. For example, but not limited to, directions may be determined from information provided by GPS 232 internal to, integrated with, or coupled to the receiving device 118. In some embodiments, the user may input geographic location information into the receiving device 118 and the directions determined therefrom. In the simplified illustrated response descriptor 402 (FIG. 4), supplemental information regarding addresses and phone numbers are provided. In the simplified illustrated response descriptor 802 (FIG. 8), supplemental information regarding prices is provided. Any suitable supplemental information may be included.

Further, the response descriptor 802 (FIG. 8) may be interactive such that the user may select one of the listed businesses to receive supplemental information associated with the selected business. For convenience, a selectable region 804 is adjacent or proximate to each listed business. The region 804 may be placed in any suitable location. The user may use any suitable menu-driven system to highlight or identify one of the regions 804 for selection. Upon selection, additional supplemental information associated with the selected listed business is presented.

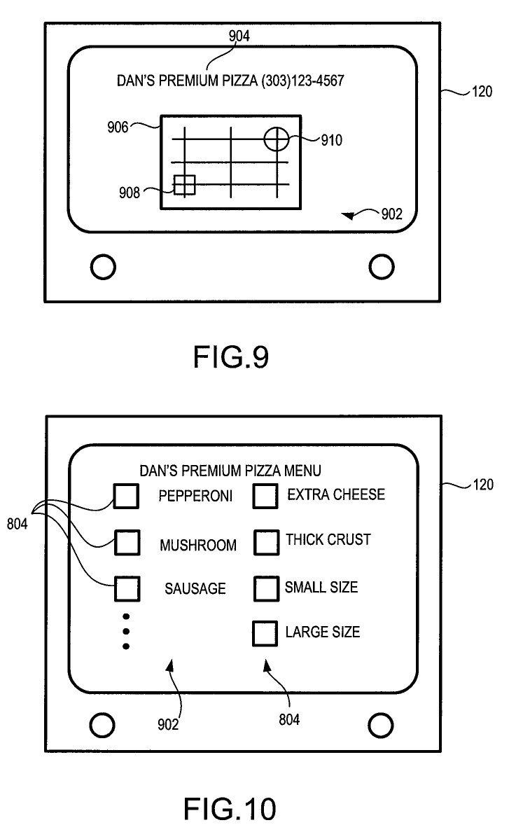

FIG. 9 illustrates an exemplary response descriptor 902 generated in response to the above-described selection of an item by the user. Here, it is apparent that the user, with respect to FIG. 9, has selected “Dan's Premium Pizza” to indicate that additional supplemental information is desired. In this example, the additional supplemental information includes a phone number 904 for “Dan's Premium Pizza” and a map 906 identifying the location 908 of “Dan's Premium Pizza.” In some embodiments, map 906 is oriented in relationship to the location 910 of the receiving device 118 (based upon the above-described customer information or based upon location information provided by the user). Further, other supplemental information of interest may be presented. As noted herein, the directions may be determined from information provided by GPS 232 or by information provided by the user.

Some embodiments may present additional supplemental information in the form of a secondary list of selectable items. FIG. 10 illustrates an exemplary response descriptor 1002 generated in response to the above-described selection of an item by the user. It is to be appreciated that the user has selected “Dan's Premium Pizza” to indicate that additional supplemental information is desired. Here, an interactive menu of food items (pizza types) is presented to the user. The user may select one of the presented items by selecting one or more regions 804, and an order for the selected item may be automatically placed with the business. Since location information is available from the above-described customer information, the location for pizza delivery may be provided with the order made interactively by the user. Further, phone number information available from the above-described customer information may be provided with the order so that the business may contact the user to confirm the order. In yet other embodiments, billing and/or account information available from the above-described customer information may be provided with the order so that the order may be automatically paid for.

In embodiments which interactively provide the user choices of additional supplemental information and/or interactive features like selectable menus, the series of generated response descriptors may be saved into a suitable memory for later retrieval. Accordingly, the user may scroll “up” or “down” through the presented series of response descriptors 1002.

Also, such embodiments may employ a suitable confirmation system to verify information that is selected by the user and communicated to the business. For example, after placing an order for a pizza with “Dan's Premium Pizza,” embodiments require confirmation from the user prior to communicating the order to the business.

G. Alternative Embodiments and Processes

Some embodiments of the query response system 100 are implemented in receiving devices 118 that are operable to communicate wirelessly to a mobile device 140 (FIG. 1). Examples of mobile devices 140 are cell phones, personal media players (PMP's), personal digital assistants (PDA's), laptop computers, handheld personal computers (HPC's), and the like. Such mobile devices 140 permit the user to electronically send, receive, create, edit, and manage information. Thus, the information corresponding to the identified party is presented on the mobile device 140 communicatively coupled to the presentation device 120.

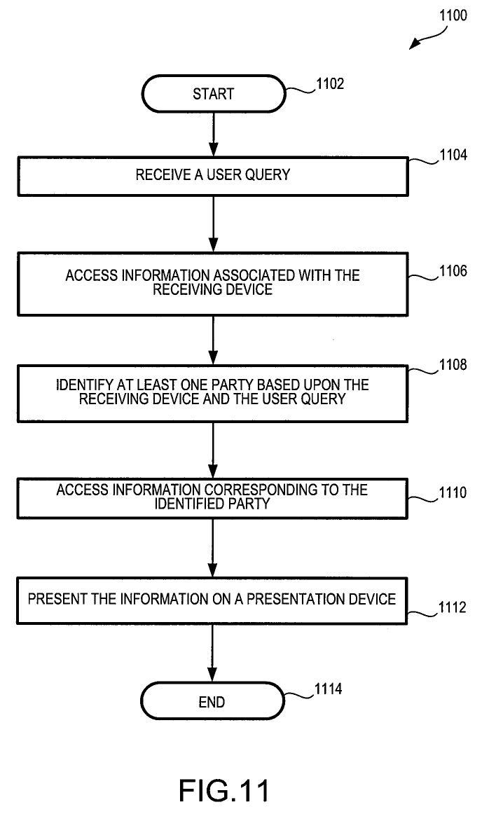

FIG. 11 is a flow chart 1100 illustrating processes used by an embodiment of the query response system 100 of FIG. 2. In this regard, each described process may represent a module, segment, or portion of code, which comprises one or more executable instructions for implementing the specified logical function(s). It should also be noted that in some implementations, the functions noted in the process may occur in a different order, may include additional functions, may occur concurrently, and/or may be omitted.

With respect to FIG. 11, the process 1100 is ongoing with operation of the receiving device 118 (FIG. 1), and is illustrated as starting at 1102. At 1104, a user query is received via a user interface. As described above, the user query corresponds to a request for information of interest. At 1106, information associated with a receiving device is accessed. At 1108, at least one party is identified based upon the receiving device information and based upon the information of interest. The at least one party may be identified from a plurality of parties corresponding to the requested information of interest. At 1110, party information is accessed from database 204. The accessed part information corresponds to the at least one identified party. At 1112, the party information is presented on a presentation device 120 communicatively coupled to the receiving device 118. The process ends at 1114.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

While various embodiments have been described hereinabove, it is to be appreciated that various changes in form and detail may be made without departing from the spirit and scope of the invention(s) presently or hereafter claimed.

1. A method for providing information, comprising:
receiving a user query via a user interface, the user query corresponding to a request for information of interest;
accessing information associated with a receiving device;
identifying at least one party based upon the receiving device information and based upon the information of interest, the at least one party being identified from a plurality of parties corresponding to the requested information of interest;
accessing party information corresponding to the at least one identified party; and
presenting the party information on a presentation device communicatively coupled to the receiving device.

2. The method of claim 1 wherein presenting the party information further comprises:
presenting at least one of a name, an address, a phone number and a descriptor of the at least one identified party.

3. The method of claim 1, further comprising:
identifying a subset of parties from the plurality of parties based upon a filtering criteria, the filtering criteria corresponding to the user information; and
presenting party information corresponding to the subset of parties.

4. The method of claim 3 wherein identifying the subset of parties based upon the filtering criteria comprises:
selecting a predefined number of parties from the subset of parties based upon a secondary filtering criteria.

5. The method of claim 3 wherein identifying the subset of parties based upon the filtering criteria comprises:
selecting a predefined number of parties from the subset of parties based upon a lowest cost of a goods or service provided by the subset of parties.

6. The method of claim 3 wherein identifying the subset of parties based upon the filtering criteria comprises:
identifying the subset of parties based upon proximity to a location associated with the receiving device.

7. The method of claim 6 wherein identifying the subset of parties based upon the filtering criteria comprises:
selecting a predefined number of the parties from the subset of parties based upon closest proximity to a location of the receiving device.

8. The method of claim 3, further comprising:
receiving a user selection of at least one party selected from the subset of parties;
accessing supplemental information pertaining to the selected party; and
presenting the supplemental information on the presentation device.

9. The method of claim 8, further comprising:
presenting a plurality of user selectable items on the presentation device with the presented supplemental information;
receiving a user selection of at least one of the items;
communicating the selected item to the selected party; and
communicating user information to the selected party.

10. The method of claim 1 wherein receiving the user query comprises:
receiving a user query identifying a party as the information of interest, wherein the identified party is identified by a name, and wherein the party information corresponds to the identified party.

11. The method of claim 1 wherein presenting the party comprises:
receiving a location of the receiving device;
determining directions to the at least one identified party; and
presenting a map indicating a location of the identified party.

12. The method of claim 6, further comprising:
receiving the location information from a global positioning system.

13. The method of claim 1, further comprising:
communicating the party information to a satellite in response to accessing the information;
receiving the party information communicated by the satellite with a satellite receiver coupled to the receiving device; and
communicating the party information from the satellite receiver to the receiving device such that the information is presented on the presentation device.

14. The method of claim 1, further comprising:
receiving a location of the receiving device;
identifying a subset of parties from the plurality of parties based upon closest proximity to the location of the receiving device; and
presenting the party information for each of the identified subset of parties.

15. The method of claim 1, in response to receiving the user query, further comprising:
presenting a query descriptor describing an attribute of the user query.

16. The method of claim 15, further comprising:
presenting a selectable region corresponding to a confirmation of the user query; and
receiving a user selection of the selectable region that indicates confirmation of the user query.

17. A system that provides information, comprising:
a receiving device communicatively coupled to a presentation device;
a user interface communicatively coupled to the receiving device and operable to communicate a user query to the receiving device, the user query corresponding to a request for information of interest;
at least one memory with a first database populated with user information associated with the receiving device and populated with information about the receiving device, and with a second database populated with information pertaining to a plurality of parties, each of the parties associated with at least one of a plurality of categories of interest;
a user query response system operable to generate a request for information corresponding to the user query; and
a search engine operable to receive the request for the information of interest requested by the user query, operable to search the second database to select at least one party corresponding to the information of interest, and operable to generate party information corresponding to the selected party so that the selected party information is presented on the presentation device.

18. The system of claim 17 wherein the search engine is operable to receive the customer information and the receiving device information such that attributes associated with the selected party are used to filter the selected party from the plurality of parties.

19. A receiving device that receives programming, comprising:
a program input module communicatively coupled to a communication system and operable to receive programming;
a user interface module operable to receive a user query corresponding to a request for information of interest;
at least one memory with a first database populated with user information associated with the receiving device and populated with information about the receiving device, and with query logic operable to process the received query; and
a processing system operable to retrieve and execute the query logic and operable generate an information request corresponding to the user query.

20. The receiving device of claim 19, comprising:
a transceiver operable to communicate the generated information request to a search engine that searches a second database to select at least one party corresponding to the information of interest, and operable to receive party information corresponding to the selected party.

21. The receiving device of claim 19, wherein a second database populated with information pertaining to a plurality of parties resides in the memory, each of the parties associated with at least one of a plurality of categories of interest, and further comprising:
a search engine operable to receive the information request, operable to search the second database to select at least one party corresponding to the information of interest, and operable to generate party information corresponding to the selected party so that the selected party information is presented on the presentation device.
